(19) United States
(12) Patent Application Publication
(10) Pub. No.: US 2013/0213191 A1
(43) Pub. Date: Aug. 22, 2013

(54) FASTENER DRIVER HAND TOOL

(71) Applicant: Milwaukee Electric Tool Corporation, (US)

(72) Inventors: Kyle Harvey, Wauwatosa, WI (US); Wade Burch, Wauwatosa, WI (US)

(73) Assignee: MILWAUKEE ELECTRIC TOOL CORPORATION, Brookfield, WI (US)

(21) Appl. No.: 13/764,067

(22) Filed: Feb. 11, 2013

Related U.S. Application Data
(60) Provisional application No. 61/600,125, filed on Feb. 17, 2012.

(51) Int. Cl. B25B 23/00; B25B 13/48; B25B 23/08

(52) U.S. Cl. CPC B25B 23/0071; B25B 23/08; B25B 13/48
USPC 81/125; 81/124.2

(57) ABSTRACT

A hand tool is configured to rotate a fastener about a rod. The hand tool includes a drive member configured to receive the fastener. The drive member includes a retainer configured to hold the fastener within the drive member against the force of gravity in any orientation of the hand tool. The hand tool also includes an opening extending through the drive member, a first handle extending radially outward from the drive member, and a second handle extending radially outward from the drive member. The first handle and the second handle are balanced to facilitate rotation of the hand tool.

### CROSS-REFERENCE TO RELATED APPLICATIONS

This application claims priority to co-pending U.S. Provisional Patent Application No. 61/600,125 filed on Feb. 17, 2012, the entire content of which is incorporated herein by reference.

### FIELD OF THE INVENTION

The present invention relates to hand tools, and more particularly to fastener driver hand tools.

### BACKGROUND

Some types of building infrastructure, such as HVAC components, pipe hangers, and cable trays are typically supported by long, threaded rods coupled to strut channel systems. One such strut channel system is the UNISTRUT® system produced by Atkore International. Fasteners, such as threaded nuts, are used for securing the building infrastructure and/or the strut channel system to the threaded rods. A conventional fastener driver such as a box-end wrench can be used to advance the nut along the rod. However, the wrench is unable to efficiently advance the nut over a long distance and must be frequently repositioned on the nut. This requires significant time and user effort. Therefore, a need exists for a fastener driver able to efficiently advance a fastener a long distance along a threaded rod.

### SUMMARY

The invention provides, in one aspect, a hand tool configured to rotate a fastener about a rod. The hand tool includes a drive member configured to receive the fastener. The drive member includes a retainer configured to hold the fastener within the drive member against the force of gravity in any orientation of the hand tool. The hand tool also includes an opening extending through the drive member, a first handle extending radially outward from the drive member, and a second handle extending radially outward from the drive member. The first handle and the second handle are balanced to facilitate rotation of the hand tool.

Other features and aspects of the invention will become apparent by consideration of the following detailed description and accompanying drawings.

### BRIEF DESCRIPTION OF THE DRAWINGS

FIG. 1 is a perspective view of a fastener driver according to one embodiment of the invention.

FIG. 2 is another perspective view of the fastener driver of FIG. 1.

FIG. 3 is a top side view of the fastener driver of FIG. 1.

FIG. 4 is a front side view of the fastener driver of FIG. 1

FIG. 5 is a perspective view of the fastener driver of FIG. 1 being used to position a fastener along a structural support.

FIG. 6 is a perspective view of a fastener driver according to another embodiment of the invention.

FIG. 7 is another perspective view of the fastener driver of FIG. 6.

FIG. 8 is a perspective view of a fastener driver according to a further embodiment of the invention.

FIG. 9 is another perspective view of the fastener driver of FIG. 8.

FIG. 10 is a perspective view of a fastener driver according to yet another embodiment of the invention.

FIG. 11 is another perspective view of the fastener driver of FIG. 10.

FIG. 12 is a perspective view of a fastener driver according to another embodiment of the invention.

FIG. 13 is another perspective view of the fastener driver of FIG. 12.

FIG. 14 is a perspective view of a fastener driver according to yet another embodiment of the invention.

FIG. 15 is another perspective view of the fastener driver of FIG. 14.

FIG. 16 is a perspective view of a fastener driver according to still another embodiment of the invention.

FIG. 17 is another perspective view of the fastener driver of FIG. 16.

FIG. 18 is a perspective view of a fastener driver according to a further embodiment of the invention.

FIG. 19 is a partial perspective view of the fastener driver of FIG. 18.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

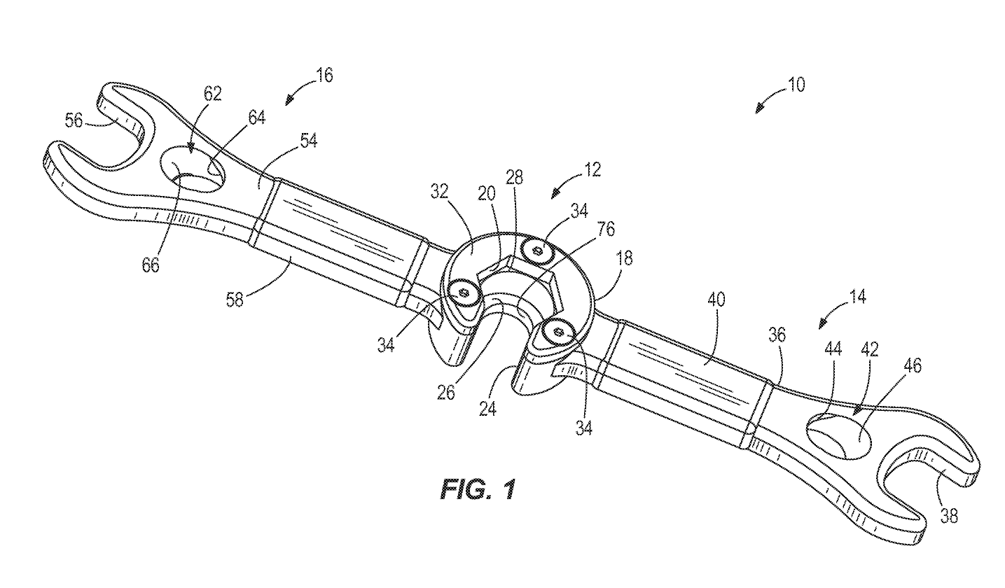

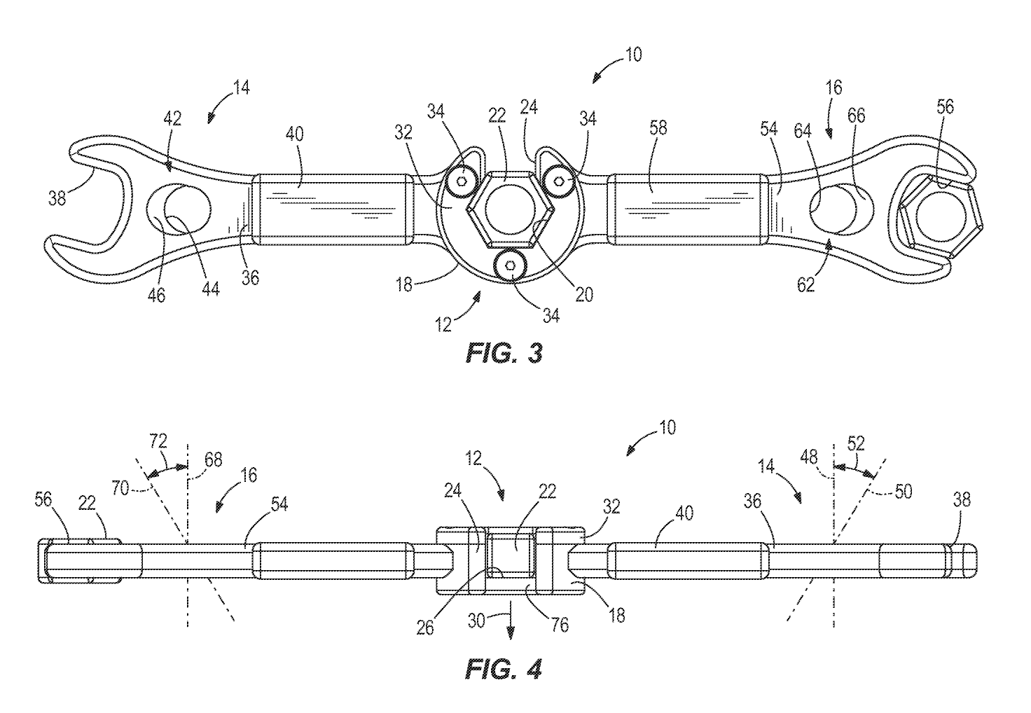

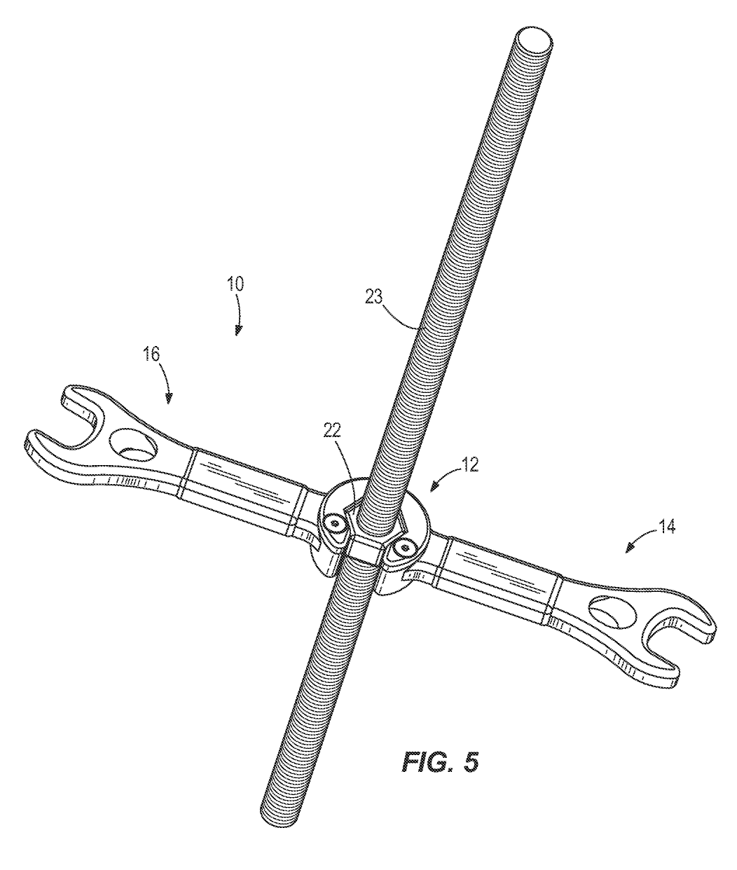

FIG. 1 illustrates a fastener driver 10 according to one embodiment of the invention. The driver 10 includes a first driver member 12, a second driver member 14, and a third driver member 16. The first driver member 12 is formed by a generally cylindrical body 18. The first driver member 12 includes a drive 20, which is a hex-shaped drive in the illustrated embodiment, and the drive 20 is located within the body 18. The hex-shaped drive 20 is configured to rotate a fastener 22 (FIG. 3), which is a hex nut in the illustrated embodiment, to move the fastener 22 along a threaded rod 23 (FIG. 5). In other embodiments, the drive 20 can be other suitable types of drives, such as a twelve point drive or a square drive. Also, the drive 20 can be configured to drive or rotate any suitable size nut, such as ½ inch, ⅜ inch, ¼ inch, and the like, which can depend on the size of the threaded rod 23.

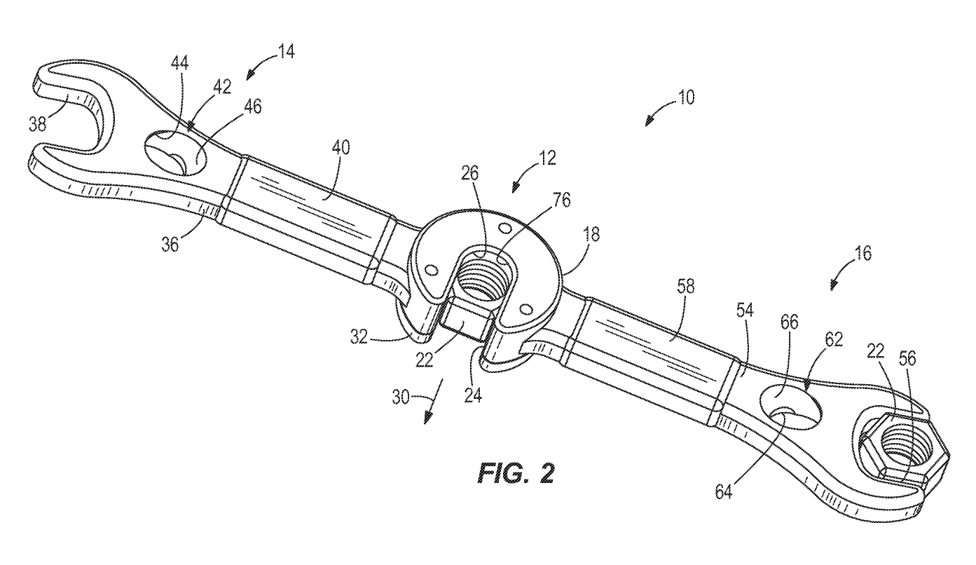

With continued reference to FIG. 1, the first driver member 12 includes an opening 24 that extends through the body 18 and through the hex-shaped drive 20, which allows the rod 23 to pass into and out of the drive 20 through the opening 24. The driver member 12 further includes a ledge 26 on which the fastener 22 sits when the fastener 22 is inserted into the drive 20 (FIG. 3). The driver member 12 further includes a retainer 28 that holds the fastener 22 within the drive 20 against the force of gravity in any orientation of the driver 10. For example, if the driver 10 is placed in the position illustrated in FIG. 2 with the fastener 22 in the position illustrated, the retainer 28 holds the fastener 22 in the drive 20 against the force of gravity acting in the direction of arrow 30 in FIG. 2. In one embodiment, the retainer 28 is formed by an elastomeric material, such as rubber. In such an embodiment, a friction force developed between the retainer 28 and the fastener 22 holds the fastener 22 within the drive 20 against the force of gravity. In other embodiments, such as some of the embodiments discussed in detail below, the retainer 28 includes a magnet. In such an embodiment, a magnetic attraction force is developed between the retainer 28 and the fastener 22 to hold the fastener 22 within the drive 20 against the force of gravity. The driver member 12 includes a cap 32 and fasteners 34, which are screws in the illustrated embodiment, that hold the retainer 28 in position against the ledge 26. The cap 32 and the fasteners 34 are removable so that a user may replace the retainer 28 if the retainer 28 becomes worn and does not properly hold the fastener 22 in position.

Referring to FIG. 1, the second driver member 14 includes an elongated handle 36 that extends from the body 18 of the first driver member 12 and a drive 38 formed at an end of the handle 36 opposite the body 18. The elongated handle 36 includes a grip 40. In one embodiment, the handle 36 is formed from steel, and the grip 40 is formed from an elastomer, such as rubber. The grip 40 provides the user with a place to grip the handle 36 or strike the handle 36 with a striking tool. The drive 38 is a box-end style wrench in the illustrated embodiment and is operable to rotate the fastener 22. The drive 38 can be any suitable size, such as ½ inch, ⅜ inch, ¼ inch, and the like.

Referring to FIGS. 3 and 4, the driver 10 further includes a rod rotating member 42 that includes a first cylindrical aperture 44 and a second cylindrical aperture 46 that both extend through the handle 36 adjacent the drive 38. The first aperture 44 defines a longitudinal axis 48 that extends centrally through the aperture 44. The axis 48 is perpendicular to the handle 36. The second aperture 46 defines a longitudinal axis 50 that extends centrally through the aperture 46. The axis 50 is at an angle 52 with respect to the axis 48. In the illustrated embodiment, the angle 52 is about 30 degrees. In other embodiments, the angle is between about 10 degrees to about 50 degrees. The axes 48 and 50 intersect within the apertures 44 and 46. In one embodiment, the first aperture 44 has a diameter that is sized to form a clearance fit with the threaded rod 23 and the second aperture 46 has a diameter that is sized to form an interference fit with the threaded rod 23. Therefore, when the threaded rod 23 extends through the apertures 44 and 46, the handle 36 grabs the rod 23 when the user rotates the handle 36 relative to the rod 23 and friction between the handle 36 and the rod 23 allows the user to rotate the threaded rod 23.

The third driver member 16 includes a second elongated handle 54 that extends from the body 18 of the first driver member 12 and a drive 56 formed at an end of the handle 54 opposite the body 18. The elongated handle 54 includes a grip 58, similar to the grip 40. The drive 56 is a box-end style wrench in the illustrated embodiment and is operable to rotate a fastener having a different size than the fastener 22. For example, the drive 38 can be sized to rotate a ⅜ inch hex nut 22 and the drive 56 can be sized to rotate a ½ inch hex nut 22. In other embodiments, the drives 38 and 56 can have other suitable combinations of sizes. In yet other embodiments, the drives 38 and 54 can be sized to rotate the same size fastener 22.

Referring to FIGS. 3 and 4, the driver 10 further includes a second rod rotating member 62 that includes a first cylindrical aperture 64 and a second cylindrical aperture 66 that extend through the handle 54 adjacent the drive 56. The first aperture 64 defines a longitudinal axis 68 that extends centrally through the aperture 64. The axis 68 is perpendicular to the handle 54. The second aperture 66 defines a longitudinal axis 70 that extends centrally through the aperture 66. The axis 70 is at an angle 72 with respect to the axis 68. In the illustrated embodiment, the angle 72 is about 30 degrees. In other embodiments, the angle is between about 10 degrees to about 50 degrees. Also, while the illustrated angle 72 is equal to the angle 52 of the first rod rotating member 42, in other embodiments, the angles 72 and 52 may differ.

The axes 68 and 70 intersect within the apertures 64 and 66. In one embodiment, the apertures 64 and 66 are the same size as the apertures 44 and 46 such that the second rod rotating member 62 is configured to rotate the same size rod 23 as the first rod rotating member 42. In other embodiments, the apertures 64 and 66 have a different size than the apertures 44 and 46 so that the second rod rotating member 62 can be used to rotate a different size rod 23 than the first rod rotating member 42. For example, in one embodiment, the first rod rotating member 42 can be sized to rotate ⅜ inch rod 23 and the second rod rotating member 62 can be sized to rotate ½ inch rod 23.

Although the illustrated driver 10 includes two elongated handles 36 and 54, in other embodiments, the driver may include more than two elongated handles. For example, in some embodiments, the driver may include four elongated handles, which can provide better balance and allow the user to quickly rotate the driver relative to the rod 23.

In operation, referring to FIGS. 1 and 5, the driver 10 is used to position the fastener 22 at a desired position along the threaded rod 23. For example, in one application, the fastener 22 is used to fasten a structural support, such as a UNISTRUT® support, at a location along the rod 23 and the structural support can support a cable tray or the like. To position the fastener 22, the user inserts the fastener 22 into the drive 20 of the first driver member 12 in the position illustrated in FIG. 3 until the fastener 22 abuts the ledge 26 as illustrated in FIG. 2. The retainer 28 holds the fastener 22 in the drive 20 against the force of gravity. Then, the user inserts the rod 23 through the fastener 22 and the user rotates the driver 10 relative to the rod 23. The user can rapidly rotate the fastener 22 by rapidly spinning the driver 10 relative to the rod 23 using handles 36 and 54. Referring to FIG. 2, the first driver member 12 includes a semi-circular guide 76 that is slightly larger than the rod 23 to limit movement of the driver 10 relative to the rod 23 when the driver 10 is rotated. In the illustrated embodiment, the second drive member 14 and the third drive member 16 are balanced to facilitate rotation of the driver 10. More specifically, the weight of the second drive member 14 (i.e., the combined weight of the handle 36 and the drive 38) and the weight of the third drive member 16 (i.e., the combined weight of the handle 54 and the drive 56) are balanced such that the driver 10 has a center of gravity C aligned with the center of the first driver member 12 (FIG. 4). Accordingly, the driver 10 is balanced in the position shown in FIG. 5, which allows the user to easily and quickly rotate the driver 10 and minimize contact between the rod 23 and the guide 76. Therefore, the user can move the fastener 22 quickly along the relatively long rod 23. When the fastener 22 is in the desired position, the user can use the drive 38 or drive 56 to finally position the fastener 22 or apply a final torque to the fastener 22 to secure the fastener 22 against the structural support.

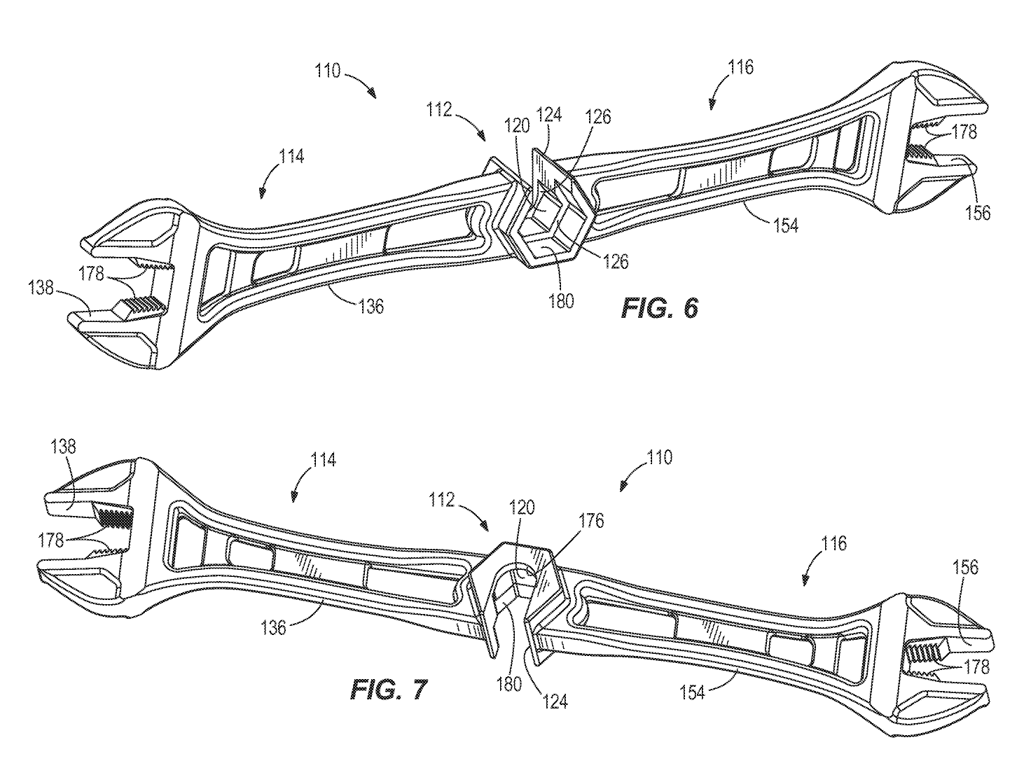

FIGS. 6 and 7 illustrate a fastener driver 110 according to another embodiment of the invention. The fastener driver 110 is similar to the fastener driver 10; therefore, like components have been given like reference numbers plus 100 and only differences between the drivers 10 and 110 will be discussed in detail. The fastener driver 110 includes grips or jaws 178 within drives 138 and 156. Similar to the rod rotating members 42 and 62 of the driver 10, the jaws 178 are used to grip the rod 23 and rotate the rod 23 to secure the rod 23 to a structural support, such as a threaded anchor that receives the rod 23 to hang the rod 23 from a ceiling, I-beam or the like. Also, the fastener driver 110 includes a first driver member 112 that includes a first drive 120 and a second drive 180. The first drive 120 is sized to rotate a fastener having a first size and the second drive 180 is sized to rotate a fastener having a second size that is larger than the first size. For example, in the illustrated embodiment, the first drive 120 is configured to rotate a ⅜ inch hex nut and the second drive 180 is configured to rotate a ¾ inch hex nut. In other embodiments, the drives 120 and 180 are configured to rotate fasteners having other size combinations.

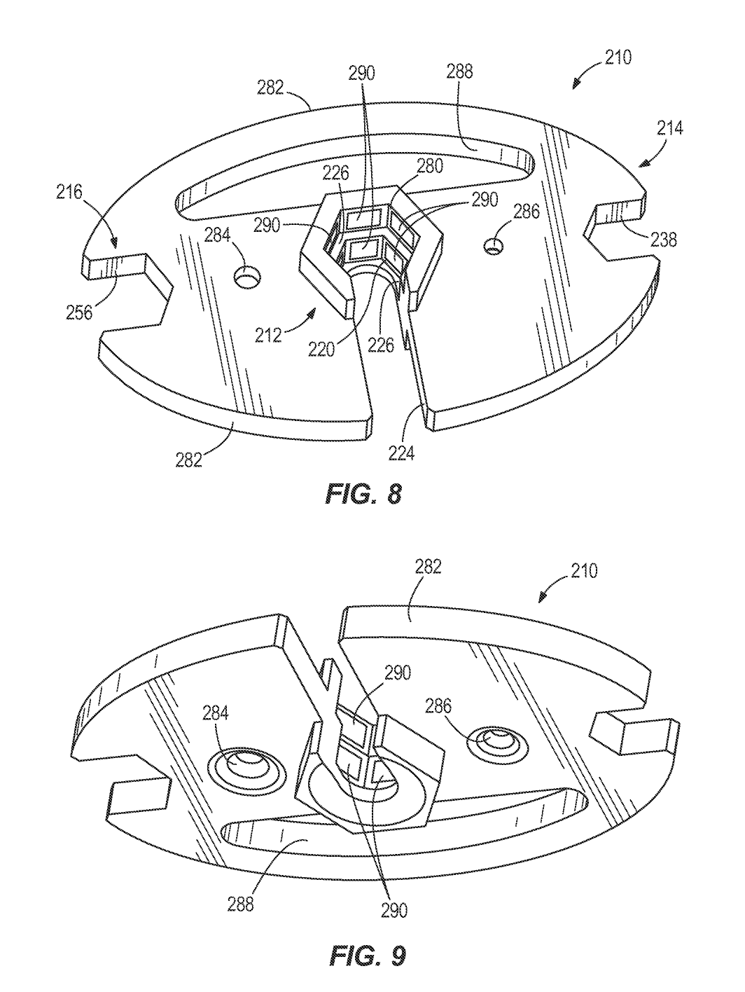

FIGS. 8 and 9 illustrate a fastener driver 210 according to another embodiment of the invention. The fastener driver 210 is similar to the fastener drivers 10 and 110; therefore, only differences between the fastener drivers 10, 110, and 210 will be discussed in detail below and like components have been given like reference numbers in the 200 series. The fastener driver 210 includes a rounded outer periphery 282 such that the driver 210 has a somewhat oval shape. The driver 210 also includes a first counter sunk aperture 284 having a first diameter and a second counter sunk aperture 286 having a second diameter, which is smaller than the diameter of the first aperture 284. The apertures 284 and 286 may be used to de-burr an end of the rod 23 (FIG. 5) after the rod 23 has been cut to length. To de-burr the rod 23, the user inserts the end of the rod 23 into one of the apertures 284, 286 (depending on the size of the rod 23), and rotates the driver 210 relative to the rod 23 to remove burrs from the rod 23. The driver 210 further includes an elongated aperture 288 that allows the user to clip the driver 210 to a tool belt, tool bucket, or the like. Also, the driver 210 includes a retainer that includes magnets 290 that hold the fastener 22 in the drives 220 and 280.

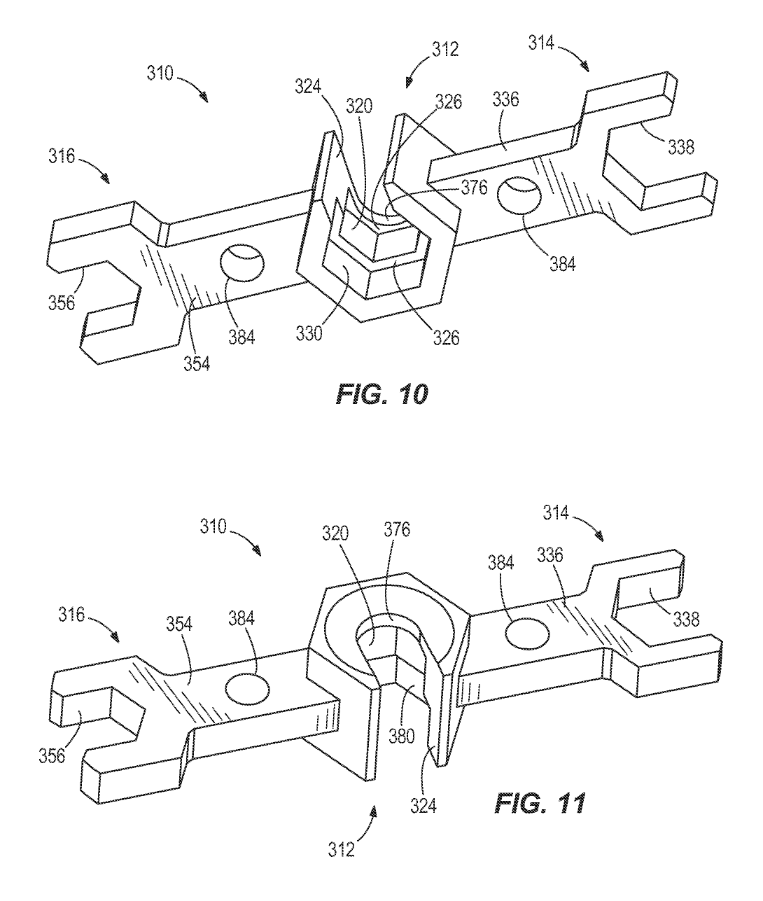

FIGS. 10 and 11 illustrate a fastener driver 310 according to another embodiment of the invention. The fastener driver 310 includes features similar to the fastener driver 210 of FIGS. 8 and 9; therefore, only differences between the fastener drivers 310 and 210 will be discussed in detail below and like components have been given like references numbers in the 300 series. The fastener driver 310 includes elongated handles 336 and 354 such that the driver 310 does not include a rounded outer periphery like the fastener driver 210 of FIGS. 8 and 9.

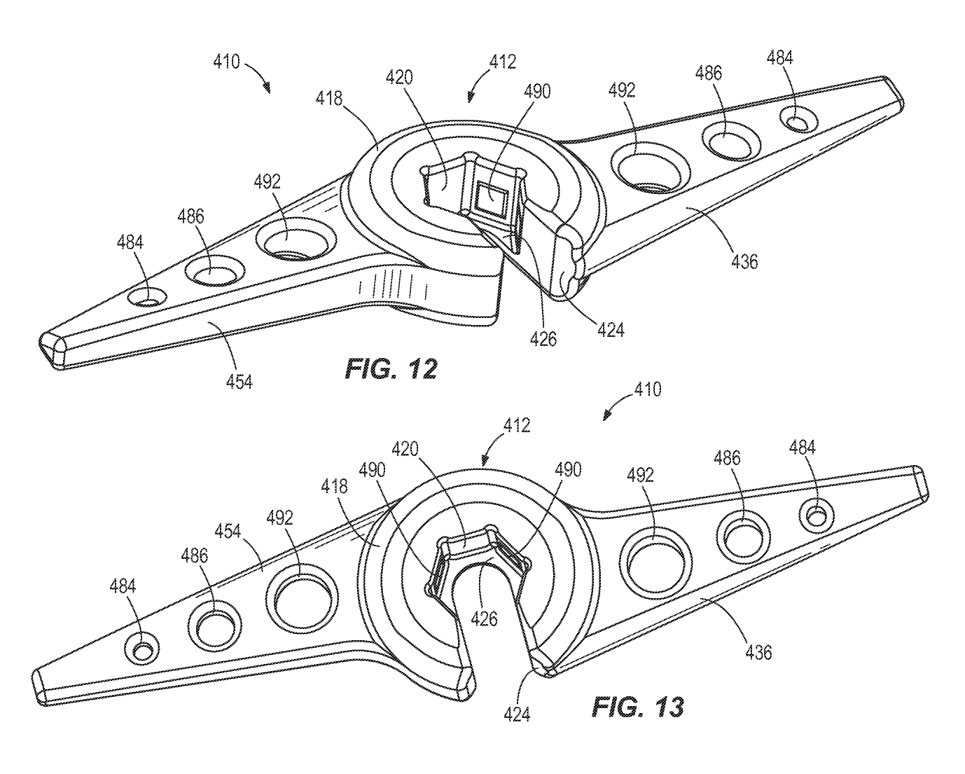

FIGS. 12 and 13 illustrate a fastener driver 410 according to another embodiment of the invention. The fastener driver 410 includes features similar to the fastener drivers 10, 110, 210, and 310 discussed above; therefore, like components have been given like reference numbers in the 400 series and only differences between the fastener drivers 10, 110, 210, 310, and 410 will be discussed in detail. The fastener driver 410 includes elongated handles 436 and 454. The handles 436 and 454 each include de-burring apertures 484, 486, and 492. The apertures 484, 486, and 492 each have a different diameter such that the apertures 484, 486, and 492 are configured to de-burr rods having different sizes.

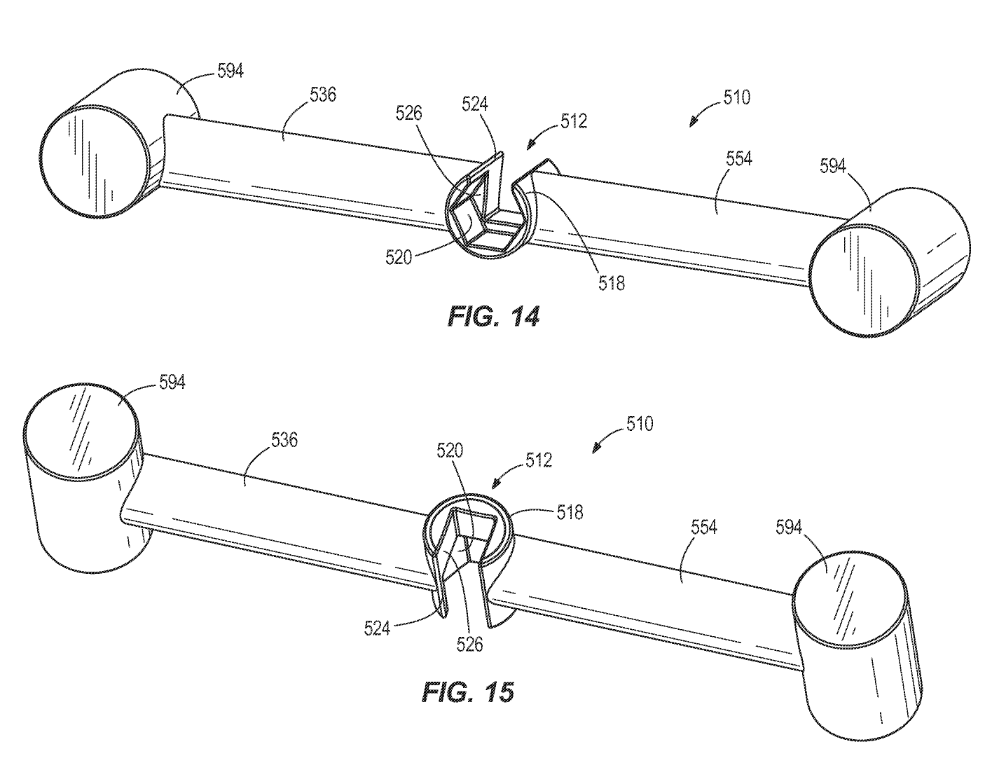

FIGS. 14 and 15 illustrate a fastener driver 510 according to another embodiment of the invention. The fastener driver 510 includes features similar to the fastener drivers 10, 110, 210, 310, and 410 discussed above; therefore, like components have been given like reference numbers in the 500 series and only differences between the fastener drivers 10, 110, 210, 310, 410, and 510 will be discussed in detail below. The fastener driver 510 includes a weight 594 located at the end of each elongated handle 536 and 554. The weights 594 balance the fastener driver 510 when it is used to rotate the fastener 22 and facilitate relatively fast rotation of the fastener driver 510 relative to the rod 23.

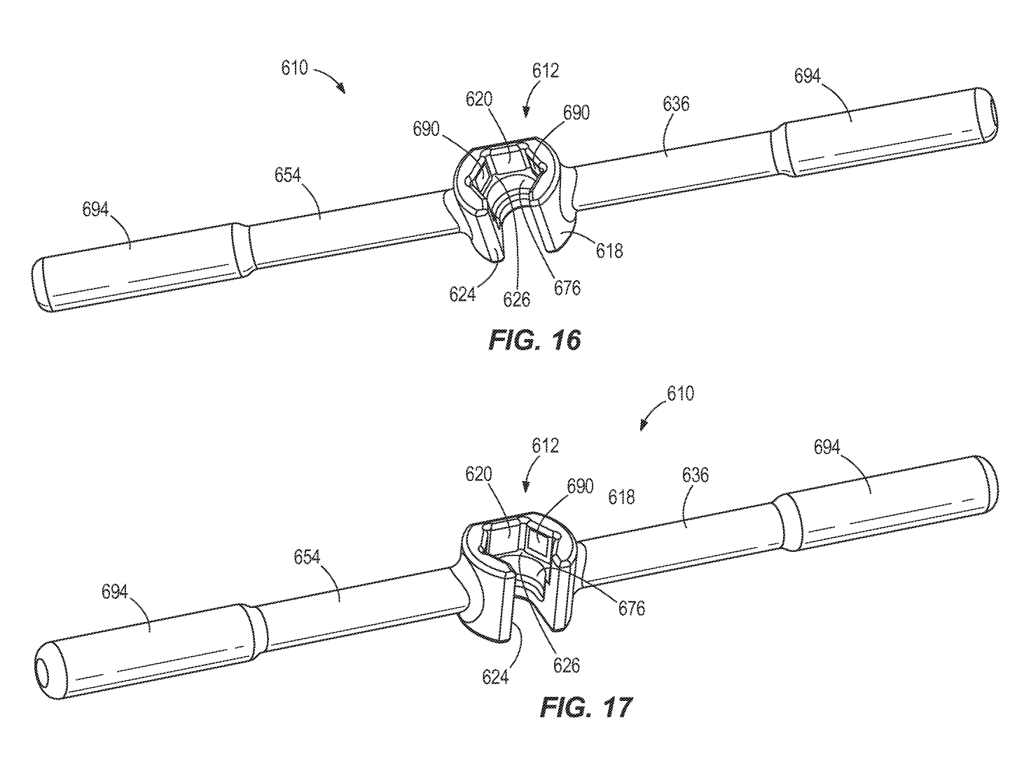

FIGS. 16 and 17 illustrate a fastener driver 610 according to another embodiment of the invention. The fastener driver 610 includes a combination of features described above with respect to one or more of the fastener drivers 10, 110, 210, 310, 410, and 510. Therefore, like components have been given like reference numbers in the 600 series.

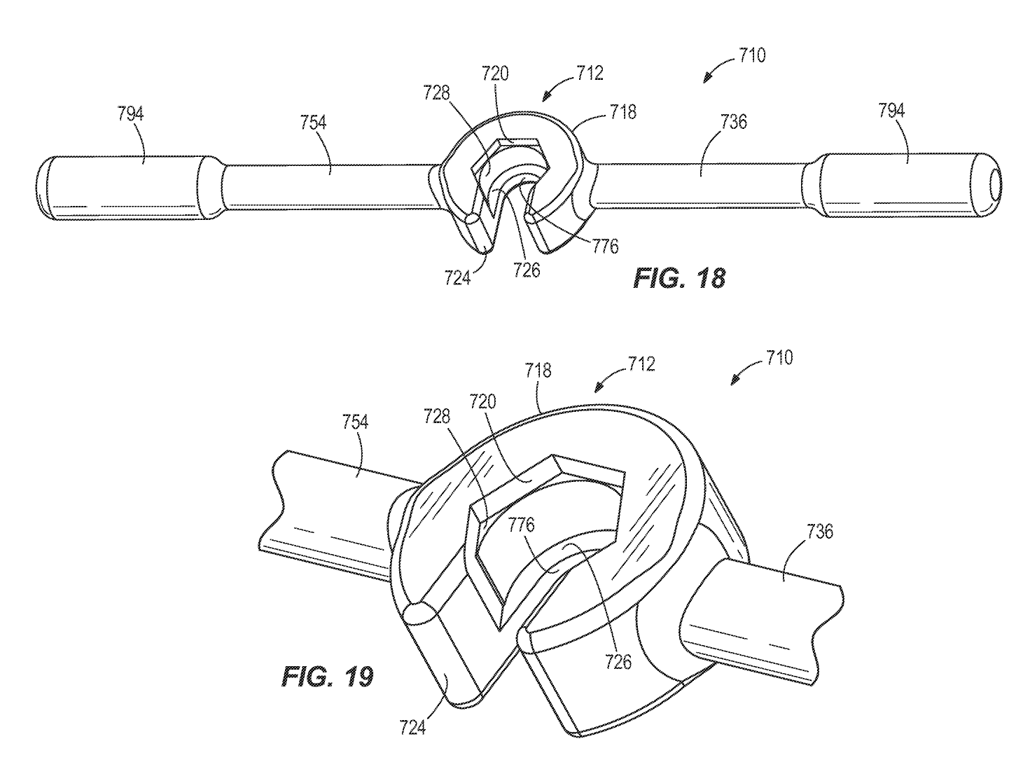

FIGS. 18 and 19 illustrate a fastener driver 710 according to another embodiment of the invention. The fastener driver 710 includes a combination of features described above with respect to one or more of the fastener drivers 10, 110, 210, 310, 410, and 510. Therefore, like components have been given like reference numbers in the 700 series.

Thus, the invention provides, among other things, a fastener driver that quickly moves a fastener along a support, such as a threaded rod, to position the fastener on the support and torque the fastener. Also, although various features of the invention have been described with respect to specific embodiments of the invention, it should be understood that various features of each embodiment can be combined to form yet other embodiments that are within the scope of the invention, but not specifically illustrated herein.

Various features of the invention are set forth in the following claims.

What is claimed is:

1. A hand tool configured to rotate a fastener about a rod, the hand tool comprising:
a drive member configured to receive the fastener, the drive member including a fastener retainer configured to hold the fastener within the drive member against the force of gravity in any orientation of the hand tool;
an opening extending through the drive member;
a first handle extending radially outward from the drive member; and
a second handle extending radially outward from the drive member,
wherein the first handle and the second handle are balanced to facilitate rotation of the hand tool.

2. The hand tool of claim 1, wherein the first handle and the second handle extend outward from the drive member in radially opposite directions.

3. The hand tool of claim 1, wherein the drive member defines a rotational axis, and wherein the hand tool includes a center of gravity substantially aligned with the rotational axis.

4. The hand tool of claim 1, wherein the drive member is a first drive member, and the hand tool further comprises a second drive member formed at an end of the first handle opposite the first drive member.

5. The hand tool of claim 4, further comprising a third drive member formed at an end of the second handle opposite the first drive member.

6. The hand tool of claim 5, wherein the third drive member includes a box-end style drive.

7. The hand tool of claim 4, wherein the second drive member includes a box-end style drive.

8. The hand tool of claim 1, wherein the drive member includes a hexagonal-shaped drive.

9. The hand tool of claim 1, wherein the drive member includes a ledge, and wherein an axial face of the fastener abuts the ledge when the fastener is held within the drive member.

10. The hand tool of claim 1, further comprising a cap removably coupled to the drive member, wherein the cap is configured to hold the retainer within the drive member when the cap is coupled to the drive member, and wherein the retainer is removable from the drive member when the cap is removed from the drive member.

11. The hand tool of claim 1, wherein the retainer is formed of an elastomeric material, and wherein friction developed between the fastener and the retainer holds the fastener within the drive member against the force of gravity.

12. The hand tool of claim 1, wherein the retainer includes at least one magnetic member, and wherein a magnetic attraction developed between the fastener and the retainer holds the fastener within the drive member against the force of gravity.

13. The hand tool of claim 1, further comprising a rod rotating member configured to rotate the rod.

14. The hand tool of claim 13, wherein the rod rotating member includes:
a first aperture extending through the first handle, the first aperture defining a first longitudinal axis extending transverse to the first handle; and
a second aperture extending through the first handle, the second aperture defining a second longitudinal axis extending at an angle relative to the first longitudinal axis,
wherein the first and second longitudinal axes intersect within the first aperture and the second aperture.

15. The hand tool of claim 14, wherein the angle is between about 10 degrees and about 50 degrees.

16. The hand tool of claim 14, wherein the first aperture is sized to form a clearance fit with the rod, and the second aperture is sized to form an interference fit with the rod.

17. The hand tool of claim 13, wherein the rod rotating member includes a pair of jaws configured to grip the rod.

18. The hand tool of claim 13, wherein the rod rotating member is a first rod rotating member, and the hand tool further comprises a second rod rotating member configured to rotate the rod.

19. The hand tool of claim 1, wherein the opening is sized to permit the rod to extend through the opening when the fastener is rotated about the rod.

20. The hand tool of claim 1, wherein the fastener is a first fastener defining a first size, and wherein the drive member is configured to receive a second fastener defining a second size greater than the first size.
